(19) United States
(12) Patent Application Publication
(10) Pub. No.: US 2020/0107337 A1
(43) Pub. Date: Apr. 2, 2020

(54) Measurement for Layer-1 Reference Signal Received Power (L1-RSRP)

(71) Applicant: MEDIATEK INC., Hsin-Chu (TW)

(72) Inventor: Hsuan-Li Lin, Hsin-Chu (TW)

(21) Appl. No.: 16/583,473

(22) Filed: Sep. 26, 2019

Related U.S. Application Data
(60) Provisional application No. 62/737,994, filed on Sep. 28, 2018.

(51) Int. Cl. H04W 72/12; H04W 24/10; H04L 1/00; H04L 5/00; H04W 56/00

(52) U.S. Cl. CPC H04W 72/1231; H04W 24/10; H04W 56/001; H04L 5/0051; H04L 1/0026

(57) ABSTRACT

Apparatus and methods are provided for L1-RSRP. In one novel aspect, L1-RSRP are performed in a measurement period based on measurement factor P and N, which are determined based on configuration information. The UE performs scheduling restriction when the measurement factor N indicates scheduling restriction is needed. In one embodiment, the L1-RSRP measurement period is extended by N to compensate the L1-RSRP measurement for receiving beam training. In another embodiment, the L1-RSRP measurement period further depends on a second measurement factor P, wherein the measurement period is extended by P to compensate the L1-RSRP measurement for one or more reference signal (RS) overlapping. In one embodiment, the RS overlapping occurs for at least one overlapping occasion comprising the L1-RSRP overlaps with SSB measurement timing configuration (SMTC), the L1-RSRP overlaps with measurement gap (MG).

### CROSS REFERENCE TO RELATED APPLICATIONS

This application claims priority under 35 U.S.C. § 119 from U.S. Provisional Application No. 62/737,994 filed on Sep. 28, 2018, titled “Measurement for L1-RSRP,” the subject matter of which is incorporated herein by reference.

### TECHNICAL FIELD

The disclosed embodiments relate generally to wireless communication, and, more particularly, to measurement for layer-1 reference signal received power (L1-RSRP).

### BACKGROUND

The bandwidth shortage increasingly experienced by mobile carriers has motivated the exploration of the underutilized millimeter wave (mmW) frequency spectrum between 3G and 300G Hz for the next generation broadband cellular communication networks, also known as new radio (NR) network. The available spectrum of mmW band is two hundred times greater than the conventional cellular system. The NR network uses multi beamforming. With recent advances in mmW semiconductor circuitry, mmW wireless system has become a promising solution for the real implementation. However, the heavy reliance on directional transmissions and the vulnerability of the propagation environment present particular challenges for the mmW network.

In the NR network, with the mmW multi-beam technology, the measurement for uplink (UL) and downlink (DL) and the measurement report needs to adapt to meet the requirement. For example, beam sweeping is required for measurement. The traditional measurement and measurement report mechanisms, such as radio link monitoring (RLM) and radio resource management (RRM) do not meet the requirement due to the multi-beam operation for the NR network.

Improvements and enhancements are required for measurement and measurement report for the NR network.

### SUMMARY

Apparatus and methods are provided for L1-RSRP. In one novel aspect, L1-RSRP are performed in a measurement period based on measurement factor P and N, which are determined based on configuration information. The UE performs scheduling restriction when the measurement factor N indicates scheduling restriction is needed. In one embodiment, the UE receives configuration information for the NR network, determines a first measurement factor N based on the configuration information, wherein the first measurement factor N indicates whether to perform a scheduling restriction, determines determining a measurement period for a layer-1 reference signal received power (L1-RSRP) based on the first measurement factor N, and performs a L1-RSRP measurement during the measurement period, wherein the L1-RSRP is performed based on at least one of configured resource sets, the configured resource sets comprising channel state information reference signal (CSI-RS) resources and synchronization signal block (SSB) resources. In one embodiment, the first measurement factor N is determined based on configuration information of the configured L1-RSRP resources type, a transmission configuration indication (TCI) state, and quasi-co-location (QCL) of L1-RSRP resources. In another embodiment, the first measurement factor N indicates to perform a scheduling restriction when the configured L1-RSRP resources type is SSB resource. In yet another embodiment, the configured L1-RSRP resources type is CSI-RS, and wherein the first measurement factor N indicates not to perform a scheduling restriction when the CSI-RS resource is configured with repetition-OFF and the TCI is given and QCL-D to SSB or CSI-RS with repetition-ON.

In one embodiment, the UE performs a scheduling restriction by suspending a predefined set of uplink transmission and downlink reception except for remaining system information (RMSI) during a scheduling restriction period. In one embodiment, the predefined set of scheduling restriction uplink transmission include a physical uplink control channel (PUCCH), a physical uplink shared channel (PUSCH), and a sound reference signal (SRS), the predefined set of scheduling restriction downlink reception includes a physical down control channel (PDCCH), a physical downlink shared channel (PDSCH), and a CSI-RS for tracking, a CSI-RS for channel quality indicator (CQI). The L1-RSRP measurement can be a computation for beam reporting or a measurement for a candidate beam detection.

In one embodiment, the L1-RSRP measurement period is extended by N to compensate for the L1-RSRP measurement for receiving beam training. In another embodiment, the L1-RSRP measurement period further depends on a second measurement factor P, wherein the measurement period is extended by P to compensate the L1-RSRP measurement for one or more reference signal (RS) overlapping. In one embodiment, the RS overlapping occurs for at least one overlapping occasion comprising the L1-RSRP overlaps with SSB measurement timing configuration (SMTC), the L1-RSRP overlaps with measurement gap (MG).

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary NR wireless network with multi-beam connections using L1-RSRP in accordance with embodiments of the current invention.

FIG. 2 illustrates an exemplary diagram for a UE to extend its measurement period for L1-RSRP by a factor P to handle RS overlapping and a factor N to handle RX beam training in accordance with embodiments of the current invention.

FIG. 3 illustrates an exemplary beam configuration for UL and DL of the UE and scheduling restriction in accordance with the current invention.

FIG. 4 illustrates an example diagram for a UE to perform L1-RSRP in a NR network with adjusted measurement period based on configuration information and performs scheduling restriction when needed in accordance with embodiments of the current invention.

FIG. 5 illustrates an exemplary diagram for the UE determining the measurement factor N in accordance with embodiments of the current invention.

FIG. 6 illustrates an exemplary diagram for determining measurement factor P for SSB-based L1-RSRP being partially overlapping with SMTC and not overlapping with measurement gap in accordance with embodiments of the current invention.

FIG. 7 illustrates an exemplary diagram for determining measurement factor P for SSB-based L1-RSRP being partially overlapping with SMTC and partially overlapping with measurement gap in accordance with embodiments of the current invention.

FIG. 8 illustrates an exemplary flow chart for the UE L1-RSRP procedure in accordance with embodiments of the current invention.

### DETAILED DESCRIPTION

Reference will now be made in detail to some embodiments of the invention, examples of which are illustrated in the accompanying drawings.

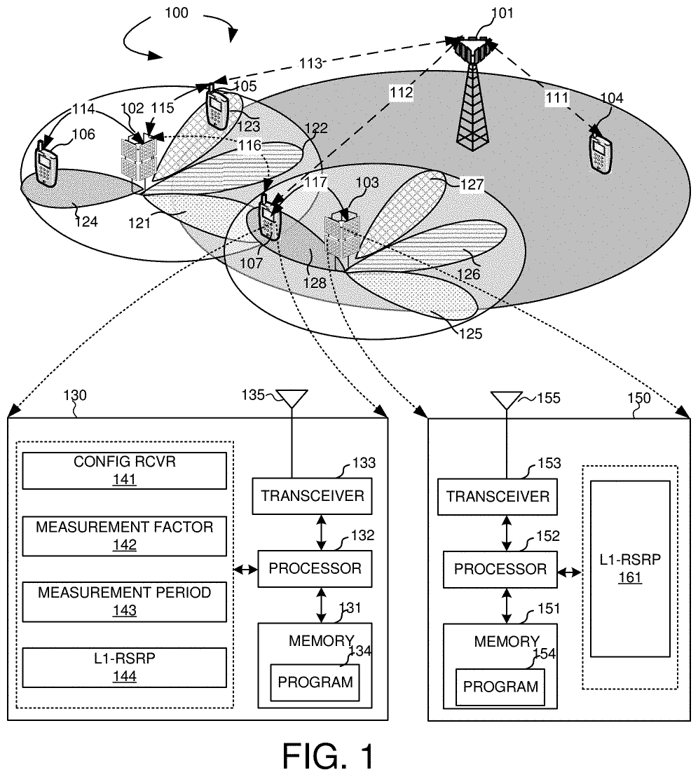

FIG. 1 is a schematic system diagram illustrating an exemplary NR wireless network 100 with multi-beam connections using Layer-1 reference signal received power (L1-RSRP) in accordance with embodiments of the current invention. NR wireless system 100 includes one or more fixed base infrastructure units forming a network distributed over a geographical region. The base unit may also be referred to as an access point, an access terminal, a base station, a Node-B, an eNode-B, or by other terminology used in the art. As an example, base stations 101, 102 and 103 serve a number of mobile stations 104, 105, 106 and 107 within a serving area, for example, a cell, or within a cell sector. In some systems, one or more base stations are coupled to a controller forming an access network that is coupled to one or more core networks. eNB 101 is a conventional base station served as a macro eNB. eNB 102 and eNB 103 are multibeam NR base station, the serving area of which may overlap with the serving area of eNB 101, as well as may overlap with each other at the edge. If the serving area of multibeam NR eNB does not overlap the serving area of macro eNB, the multibeam NR eNB is considered as standalone, which can also provide service to users without the assistance of macro eNB. multibeam NR eNB 102 and multibeam NR eNB 103 has multiple sectors each with multiple control beams to cover a directional area. Control beams 121, 122, 123 and 124 are exemplary control beams of eNB 102. Control beams 125, 126, 127 and 128 are exemplary control beams of eNB 103. As an example, UE or mobile station 104 is only in the service area of eNB 101 and connected with eNB 101 via a link 111. UE 106 is connected with multibeam NR base station only, which is covered by control beam 124 of eNB 102 and is connected with eNB 102 via a link 114. UE 105 is in the overlapping service area of eNB 101 and eNB 102. In one embodiment, UE 105 is configured with dual connectivity and can be connected with eNB 101 via a link 113 and eNB 102 via a link 115 simultaneously. UE 107 is in the service areas of eNB 101, eNB 102, and eNB 103. In embodiment, UE 107 is configured with dual connectivity and can be connected with eNB 101 with a link 112 and eNB 103 with a link 117. In one embodiment, UE 107 can switch to a link 116 connecting to eNB 102 upon connection failure with eNB 103.

FIG. 1 further illustrates simplified block diagrams 130 and 150 for UE 107 and eNB 103, respectively. Mobile station 107 has an antenna 135, which transmits and receives radio signals. A RF transceiver module 133, coupled with the antenna, receives RF signals from antenna 135, converts them to baseband signal, and sends them to processor 132. RF transceiver 133 also converts received baseband signals from processor 132, converts them to RF signals, and sends out to antenna 135. Processor 132 processes the received baseband signals and invokes different functional modules to perform features in mobile station 107. Memory 131 stores program instructions and data 134 to control the operations of mobile station 107. Mobile station 107 also includes multiple function modules that carry out different tasks in accordance with embodiments of the current invention. Configuration receiver 141 receives configuration information for measurement report from the NR network. Measurement factor circuit 142 determines a first measurement factor N based on the configuration information, wherein the first measurement factor N and a second measurement factor P based on the configuration information, wherein the first measurement factor N indicates whether to perform a scheduling restriction, and wherein a measurement period for a layer-1 reference signal received power (L1-RSRP) is extended by P to compensate the L1-RSRP measurement for one or more reference signal (RS) overlapping. Measurement period circuit 143 determines the L1-RSRP measurement period based on the first measurement factor N and the second measurement factor P. L1-RSRP circuit 144 performs L1-RSRP measurement during the L1-RSRP measurement period, wherein the L1-RSRP is performed on at least one configured resources comprising channel state information reference signal (CSI-RS) resources and synchronization signal block (SSB) resources.

Similarly, eNB 103 has an antenna 155, which transmits and receives radio signals. An RF transceiver module 153, coupled with the antenna, receives RF signals from antenna 155, converts them to baseband signals, and sends them to processor 152. RF transceiver 153 also converts received baseband signals from processor 152, converts them to RF signals, and sends out to antenna 155. Processor 152 processes the received baseband signals and invokes different functional modules to perform features in eNB 103. Memory 151 stores program instructions and data 154 to control the operations of eNB 103. eNB 103 also includes multiple function modules that carry out different tasks in accordance with embodiments of the current invention. L1-RSRP handler 161 communicates with the UEs and performs L1-RSRP related functions.

UE measurement and measurement report are important procedures. In one novel aspect, layer-1 reference signal received power (L1-RSRP) is proposed for measurement reporting for a multibeam NR wireless network. Conventional network provides several measurement procedures, such as RLM, beam failure detection (BFD) and candidate beam detection (CBD). While the above measurement procedures provide the necessary information in the traditional wireless network, there are differences. The traditional measurement procedures above are configured by the radio resource control (RRC) layer on a per bandwidth part basis. The L1-RSRP, however, are configured on a per cell basis. In one embodiment, the L1-RSRP are configured by the RRC layer. Further, the RLM is used in the LTE network, while the BFD, CBD, and L1-RSRP can be used for the NR network. Although the existing measurement procedures with some functionalities can be also used for the NR network, there are many differences from the L1-RSRP. For example, the RLM is to monitor radio link quality of a cell and it would trigger RLF (radio link failure) and a new cell access procedure. The BFD is to monitor radio link quality of a beam, and it would trigger beam failure and link recovery procedure. The CBD provides measurement results for link recovery procedure on a conditional basis. For example, upon detecting a beam failure during the BFD, the CBD is triggered. L1-RSRP, however, provides regular measurement results for beam management at the background. Further, the RLM and BFD measures signal to interference and noise ratio (SINR) and/or block error rate (BLER). While the CBD and L1-RSRP measure RSRP. However, CBD does not report the measured RSRP to the network, while L1-RSPR does. Furthermore, the traditional measurement procedures, such as the RLM, the BFD, and the CBD, measures PCell and PSCell, while the L1-RSRP measures all serving cells and SCell.

The L1-RSRP measurement means to perform RSRP measurement at layer-1. It can run at the background and provides the measurement report to the network. The L1-RSRP measurement includes measuring and reporting L1-RSRP as well as measuring RSRP for CBD. For RRM with intra-frequency measurement, the UE will train its RX beam with different directions during SMTC, and the direction may be different from the direction of the serving synchronization signal block (SSB). The UE may, therefore, miss the scheduled data or to be required to support simultaneously multi-directional measurements while performing L1-RSRP. Corresponding measurement procedures are required.

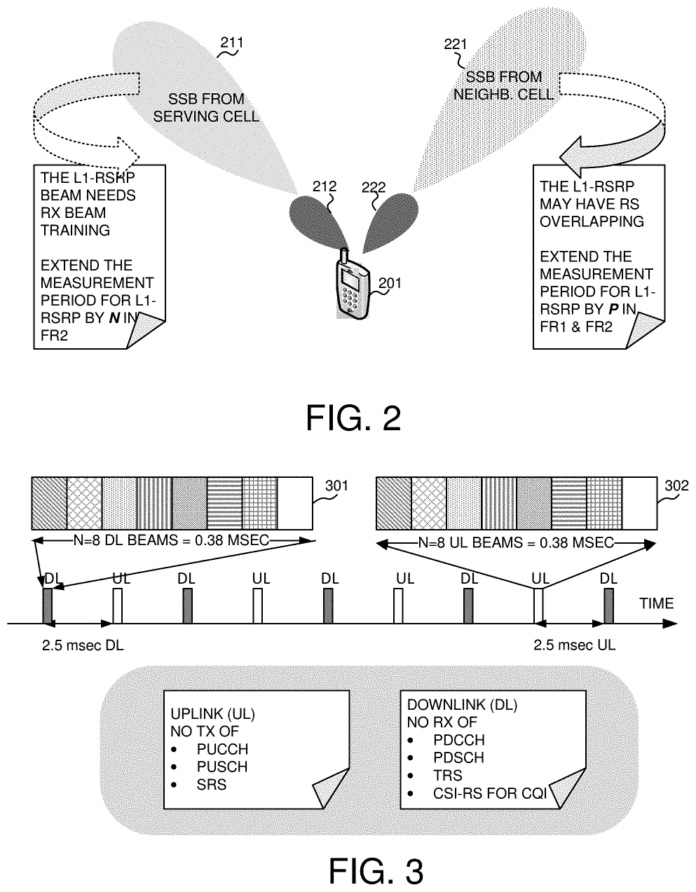

FIG. 2 illustrates an exemplary diagram for a UE to extend its measurement period for L1-RSRP by a factor P to handle reference signal overlapping and a factor N to handle receiver (RX) beam training in accordance with embodiments of the current invention. UE 201 is connected with a serving cell with beam 211 in an NR wireless network. The UE may operate in frequency range-1 (FR1), which is in the range of smaller than 6 GHZ or 7 GHz. The UE may also operate in frequency range-2 (FR2), which is in the range of about 28 GHz where millimeter wave (mmW) resides. The UE operates in FR2 perform Rx beamforming. The UE performs L1-RSRP measurement based on L1-RSRP resources such as the synchronization signal block (SSB) resources or the channel state information reference signal (CSI-RS) resources with beam 212. As the UE performs the L1-RSRP, the UE needs to train the beam within the serving cell beams. During the training, the beam measurement may not be valid. Therefore, to compensate for the RX beam training, the UE needs to extend the measurement period for the L1-RSRP by a factor of N in the FR2. In one embodiment, the measurement factor N is determined based on RRC configuration information.

The L1-RSRP measurements would be impacted by the measurements on neighbor cell beams, both in the FR1 and FR2. UE 201 measures SSB neighboring cell beam 221. UE 201 performs L1-RSRP with beam 222. In an NR network, the UE is configured with SSB measurement timing configuration (SMTC) and measurement gap (MG). The SS/PBCH block (SSB) burst consists of multiple SSB-s, which are associated with the different SSB indices and potentially with the different transmission beams. Besides, the CSI-RS signals can also be configured for beam management and measurement. The SMTC with a certain duration and periodicity is used to indicate the UE measurement on the certain resources to reduce the UE power consumptions. Within the SMTC period and on the configured SSB and/or CSI-RS, UE will conduct the L1-RSRP/RLM/RRM measurement. Measurement gap is configured to create a small gap during which no transmission and reception would happen. Since there is no signal transmission and reception during the gap, the UE can switch to the target cell and perform the signal quality measurement and come back to the current cell. Once such original L1-RSRP measurement period overlaps with the SMTC and/or MG, the L1-RSRP measurement results would be influenced. Therefore, the original L1-RSRP measurement period should be extended by a measurement factor P to become a new L1-RSRP measurement period in FR1 and FR2 to handle the RS overlapping.

In one novel aspect, scheduling restriction are applied for L1-RSRP measurements. In an NR network, there are different subcarrier spacing (SCS) between the SSB and the data. Since the Rx beam for data reception is fixed, the Rx beam sweeping is required for the UE measurement. Therefore, the UE in an NR network is not required to simultaneously perform measurement and data reception. Therefore, in certain conditions, the UE needs to apply the scheduling restriction.

FIG. 3 illustrates an exemplary beam configuration for uplink (UL) and downlink (DL) of the UE and UL and DL scheduling restriction in accordance with the current invention. The DL and UL are divided in the time domain with multi beamforming. In one embodiment, A DL frame 301 has eight DL beams occupying a total of 0.38 msec. A UL frame 302 has eight UL beams occupying a total of 0.38 msec. The interval between the UL frame and the DL frame is 2.5 msec. The UL and DL both have control beams for signaling and dedicated beams for data transmission. Since the UE does not perform L1-RSRP measurement and data reception simultaneously, the UE needs to apply scheduling restriction in certain situations to perform the L1-RSRP measurement. When the scheduling restriction is applied, the UE is not expected to transmit physical uplink control channel (PUCCH), physical uplink shared channel (PUSCH) and sound reference signal (SRS) transmission for the UL OFDM symbols with scheduling restriction. The UE is also not expected to receive physical downlink control channel (PDCCH), physical downlink shared channel (PDSCH), a CSI-RS for tracking, and a CSI-RS for channel quality indicator (CQI) on the OFDM downlink symbols with scheduling restriction, except for the remaining system information (RMSI) symbols.

The L1-RSRP measurement procedure for the UE in the NR network provides measurement and measurement reports that meet the requirement for a multi-beam network. In one novel aspect, the UE determines the measurement period for the L1-RSRP by applying a measurement factor P to handle reference signal (RS) overlapping and a measurement factor N to handle the RX beam training. The measurement factor P and measurement factor N are determined based on configuration information received from the network. In one embodiment, based on the configuration information, the UE also determines whether the scheduling restriction applies and performs scheduling restriction when conditions are met.

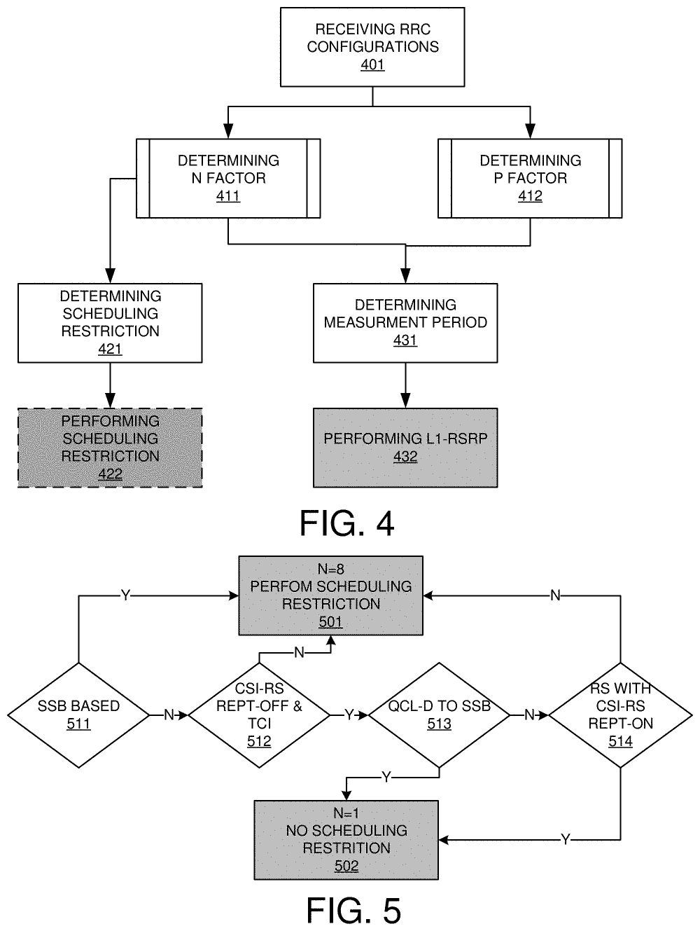

FIG. 4 illustrates an example diagram for a UE to perform L1-RSRP measurements in an NR network with adjusted measurement period based on configuration information and scheduling restriction is applied when needed in accordance with embodiments of the current invention. At step 401, the UE receives configuration information. In one embodiment, the configuration information is included in RRC configurations. The RRC configurations may include the SMTC, MG and L1-RSRP for reporting information. Upon receiving the configuration information, at step 411, the UE determines a first measurement factor N. In one embodiment, the UE determines that N=8 if the L1-RSRP measurement is SSB based, which means the L1-RSRP is performed on the SSB resources. In another embodiment, the UE determines that N=1 if the L1-RSRP measurement is CSI-RS based and if a set of CSI-RS conditions are met. In one embodiment, the CSI-RS condition is met if CSI-RS resources are configured with repetition-OFF and the transmission configuration indication (TCI) is given and either QCL-D to SSB or at one resource in the CSI-RS resource set is configured with repetition-ON. In one embodiment, the repetition-OFF is configured when higher layer parameter repetition set to OFF for the CSI-RS resource in a resource set configured.

In one embodiment, the UE determines whether to perform the scheduling restriction based on the determined measurement factor N. If N=1, there is no scheduling restriction. If N=8, at step 422, the UE performs scheduling restriction by skipping PUCCH/PUSCH transmission and PDCCH/PDSCH reception, except for RMSI, on the OFDM symbol with scheduling restriction. The scheduling restriction may also be performed on UL SRS and DL TRS and CSI-RS for CQI.

In another embodiment, a second measurement factor P is determined, at step 431 based on configuration information received. At step 432, the UE determines the measurement period for the L1-RSRP by applying the measurement factor N and measurement factor P. At step 432, the UE performs L1-RSRP measurement according to the determined measurement period.

The scheduling restriction may apply due to L1-RSRP computation for reporting or may apply due to L1-RSRP for CBD. In one embodiment, the scheduling restriction applies due to L1-RSRP computation for reporting on an FR2 serving cell in the following situations. When the L1-RSRP reporting is CSI-RS based, there are no scheduling restrictions due to L1-RSRP computation for reporting based on CSI-RS, if the CSI-RS configured with repetition-OFF and the TCI is given and QCL-D to SSB or CSI-RS with repetition-ON, which is N=1 applies. Otherwise, the UE is not expected to transmit PUCCH/PUSCH or receive PDCCH/PDSCH on CSI-RS symbols to be measured for L1-RSRP computation for reporting, except for RMSI PDCCH/PDSCH and PDCCH/PDSCH which is not required to be received by RRC CONNECTED mode UE. When the L1-RSRP reporting is SSB based, the UE is not expected to transmit PUCCH/PUSCH or receive PDCCH/PDSCH on SSB symbols to be measured for L1-RSRP computation for reporting, except for RMSI PDCCH/PDSCH and PDCCH/PDSCH which is not required to be received by RRC CONNECTED mode UE.

In another embodiment, the scheduling restriction applies due to L1-RSRP computation for CBD on an FR2 serving cell in the following situations. When the L1-RSRP CBD is CSI-RS based, there are no scheduling restrictions due to L1-RSRP for candidate beam detection based on CSI-RS, if the CSI-RS configured with repetition-OFF and the TCI is given and QCL-D to SSB or CSI-RS with repetition-ON (i.e. N=1 applies). Otherwise, the UE is not expected to transmit PUCCH/PUSCH or receive PDCCH/PDSCH on CSI-RS symbols to be measured for L1-RSRP for candidate beam detection, except for RMSI PDCCH/PDSCH and PDCCH/PDSCH which is not required to be received by RRC CONNECTED mode UE. When the L1-RSRP CBD is SSB based, the UE is not expected to transmit PUCCH/PUSCH or receive PDCCH/PDSCH on SSB symbols to be measured for L1-RSRP for candidate beam detection, except for RMSI PDCCH/PDSCH and PDCCH/PDSCH which is not required to be received by RRC CONNECTED mode UE. The UE determines whether to perform the scheduling restriction based on the measurement factor N.

FIG. 5 illustrates an exemplary diagram for the UE determining the measurement factor N in accordance with embodiments of the current invention. At step 511, the UE determines whether the L1-RSRP is SSB based or CSI-RS based. If step 511 determines that the L1-RSRP is SSB based, the UE determines, at step 501, that N=8 and that the UE will perform scheduling restriction. If step 511 determines it is CSI-RS based L1-RSRP, the UE, at step 512, determines whether the CSI-RS is configured with REPETITION-OFF and the TCI state is active. In one embodiment, the “repetition-OFF” can refer to “repetition” in NZP-CSI-RS-ResourceSet information element is configured as “OFF”. If step 512 determines no, the UE moves to step 501 and determines that N=8 and that the UE will perform scheduling restriction. If step 512 determines yes, the UE moves to step 513 and determines whether the UE is configured with QCL-D to SSB. If step 513 determines yes, the UE moves to step 502 and determines that N=1 and that the UE will not perform scheduling restriction. If step 513 determines no, the UE moves to step 514 and determines if at least one resource is configured with REPETITION-ON. If step 514 determines no, the UE moves to step 501 and determines that N=8 and that the UE will perform scheduling restriction. If step 514 determines yes, the UE moves to step 502 and determines that N=1 and that the UE will not perform scheduling restriction.

In one embodiment, the UE determines the measurement period for the L1-RSRP further based on the measurement factor P. The measurement factor P is determined based on the configuration information.

In a first scenario, P=1/(1−T_{RS_L1-RSRP}/T_{SMTCperiod}) when RS for L1-RSRP is not overlapped with measurement gap and RS for L1-RSRP is partially overlapped with SMTC occasion, where T_{RS_L1-RSRP}<T_{SMTCperiod}.

In a second scenario, P is 3, when RS for L1-RSRP is not overlapped with measurement gap and RS for L1-RSRP is fully overlapped with SMTC period, where T_{RS_L1-RSRP}=T_{SMTCperiod}.

In a third scenario, P is 1/(1−T_{RS_L1-RSRP}/MGRP−T_{RS_L1-RSRP}/T_{SMTCperiod}), when RS for L1-RSRP is partially overlapped with measurement gap and RS for L1-RSRP is partially overlapped with SMTC occasion, where T_{RS_L1-RSRP}<T_{SMTCperiod} and SMTC occasion is not overlapped with measurement gap and either T_{SMTCperiod}≠MGRP or the following condition is true: T_{SMTCperiod}=MGRP and T_{RS_L1-RSRP}<0.5*T_{SMTCperiod}.

In a fourth scenario, P is 1/(1−T_{RS_L1-RSRP}/MGRP)*3, when RS for L1-RSRP is partially overlapped with measurement gap and RS for L1-RSRP is partially overlapped with SMTC occasion, where T_{RS_L1-RSRP}<T_{SMTCperiod} and SMTC occasion is not overlapped with measurement gap and T_{SMTCperiod}=MGRP and T_{SSB}=0.5*T_{SMTCperiod}.

In a fifth scenario, P is 1/{1−T_{RS_L1-RSRP}/min (T_{SMTCperiod},MGRP)}, when RS for L1-RSRP is partially overlapped with measurement gap and RS for L1-RSRP is partially overlapped with SMTC occasion, where T_{RS_L1-RSRP}<T_{SMTCperiod} and SMTC occasion is partially or fully overlapped with measurement gap.

In a sixth scenario, P is 1/(1−T_{RS_L1-RSRP}/MGRP)*3, when RS for L1-RSRP is partially overlapped with measurement gap and RS for L1-RSRP is fully overlapped with SMTC occasion, where T_{RS_L1-RSRP}=T_{SMTCperiod} and SMTC occasion is partially overlapped with measurement gap, where T_{SMTCperiod}<MGRP.

In summary, the measurement factor P is based on the SMTC, MG and L1-RSRP configuration. The following diagrams illustrate some exemplary scenarios.

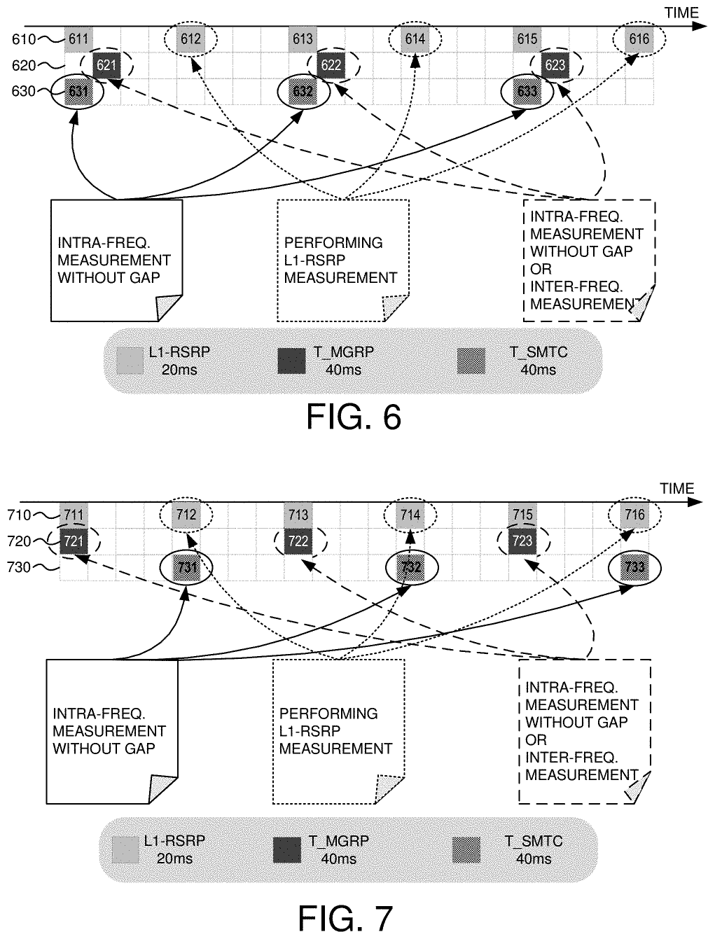

FIG. 6 illustrates an exemplary diagram for determining measurement factor P for SSB-based L1-RSRP being partially overlapping with SMTC and not overlapping with measurement gap in accordance with embodiments of the current invention. The UE is configured with L1-RSRP 610 with T_L1-RSRP=20 ms, measurement gap 620 with T_MGRP=40 ms, and SMTC 630 with T_SMTC=40 ms. Based on the L1-RSRP configuration, the UE would perform L1-RSRP at time 611, 612, 613, 614, 615, and 616. Based on MG configuration, the UE would perform intra-frequency measurement without gap or inter-frequency measurement at time 621, 622 and 623. Based on the SMTC configuration, the UE would perform intra-frequency measurement without gap at time 631, 632 and 633. As shown, the L1-RSRP is not overlapped with the MG. However, the L1-RSRP is partially overlapped with SMTC at 611 and 631; 613 and 632; 615 and 633. In this scenario, the measurement factor P should apply. The P is determined based on the configuration. Because the L1-RSRP is partially overlapped with SMTC, and T_{L1-RSRP}<T_{SMTCperiod}, P=1/{1−T_L1-RSRP/T_SMTC}. Here, T_L1-RSRP=20 ms. T_SMTC=40 ms. Therefore, P=2.

FIG. 7 illustrates an exemplary diagram for determining measurement factor P for SSB-based L1-RSRP being partially overlapping with SMTC and partially overlapping with measurement gap in accordance with embodiments of the current invention. The UE is configured with L1-RSRP 710 with T_L1-RSRP=20 ms, measurement gap 720 with T_MGRP=40 ms, and SMTC 730 with T_SMTC=40 ms. Based on the L1-RSRP configuration, the UE would perform L1-RSRP at time 711, 712, 713, 714, 715, and 716. Based on MG configuration, the UE would perform intra-frequency measurement without gap or inter-frequency measurement at time 721, 722 and 723. Based on the SMTC configuration, the UE would perform intra-frequency measurement without gap at time 731, 732 and 733. As shown, the L1-RSRP is partially overlapped with the MG at 711 and 721, 713 and 722; 715 and 723. The L1-RSRP is partially overlapped with SMTC at 712 and 731; 714 and 732; and 716 and 733. In this scenario, the measurement factor P should apply. The P is determined based on the configuration. Because the L1-RSRP is partially overlapped with SMTC, and T_{L1-RSRP}<T_{SMTCperiod}, P=1/{1−T_L1-RSRP/T_MGRP}*RSF_b. Here, T_L1-RSRP=20 ms. T_MGRP=40 ms. RSF_b=2, Therefore, P=4.

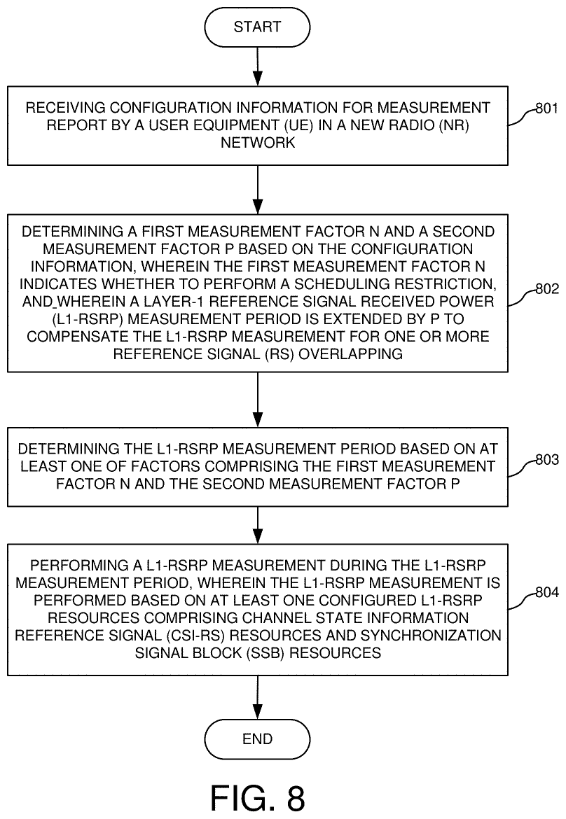

FIG. 8 illustrates an exemplary flow chart for the UE L1-RSRP procedure in accordance with embodiments of the current invention. At step 801, the UE receives configuration information for measurement report in an NR network. At step 802, the UE determines a first measurement factor N and a second measurement factor P based on the configuration information, wherein the first measurement factor N indicates whether to perform a scheduling restriction and wherein a layer-1 reference signal received power (L1-RSRP) measurement period is extended by P to compensate the L1-RSRP measurement for one or more reference signal (RS) overlapping. At step 803, the UE determines the L1-RSRP measurement period for based on at least one factors comprising the first measurement factor N and the second factor P. At step 804, the UE performs a a L1-RSRP measurement during the L1-RSRP measurement period, wherein the L1-RSRP measurement is performed based on at least one configured L1-RSRP resources comprising channel state information reference signal (CSI-RS) resources and synchronization signal block (SSB) resources.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving configuration information for measurement report by a user equipment (UE) in a new radio (NR) network;
determining a first measurement factor N and a second measurement factor P based on the configuration information, wherein the first measurement factor N indicates whether to perform a scheduling restriction, and wherein a layer-1 reference signal received power (L1-RSRP) measurement period is extended by P to compensate the L1-RSRP measurement for one or more reference signal (RS) overlapping;
determining the L1-RSRP measurement period based on at least one of factors comprising the first measurement factor N and the second measurement factor P; and
performing a L1-RSRP measurement during the L1-RSRP measurement period, wherein the L1-RSRP measurement is performed based on at least one configured L1-RSRP resources comprising channel state information reference signal (CSI-RS) resources and synchronization signal block (SSB) resources.

2. The method of claim 1, wherein the first measurement factor N is determined based on configuration information of the configured L1-RSRP resources, a transmission configuration indication (TCI) state, and quasi-co-location (QCL) of the configured resources.

3. The method of claim 2, wherein the first measurement factor N indicates to perform a scheduling restriction when the configured resource is SSB.

4. The method of claim 2, wherein the configured L1-RSRP resource is CSI-RS resource, and wherein the first measurement factor N indicates no scheduling restriction when the CSI-RS resource is configured with repetition-OFF and the TCI is given and QCL-D to SSB resource or CSI-RS resource with repetition-ON.

5. The method of claim 1, wherein when a scheduling restriction is applied to the UE, the UE does not transmit a predefined set of uplink transmission and downlink reception except for remaining system information (RMSI) during a scheduling restriction period.

6. The method of claim 5, wherein the predefined set of uplink transmission include a physical uplink control channel (PUCCH), a physical uplink shared channel (PUSCH), and a sound reference signal (SRS), the predefined set of downlink reception includes a physical down control channel (PDCCH), a physical downlink shared channel (PDSCH), and a CSI-RS for tracking, a CSI-RS for channel quality indicator (CQI).

7. The method of claim 1, wherein the L1-RSRP measurement is a L1-RSRP procedure for a candidate beam detection.

8. The method of claim 1, wherein the L1-RSRP measurement is a L1-RSRP computation for beam reporting.

9. The method of claim 1, wherein the measurement period is extended by N to compensate the L1-RSRP measurement for receiving beam training.

10. The method of claim 1, wherein the RS overlapping occurs for at least one overlapping occasion comprising the L1-RSRP overlaps with SSB measurement timing configuration (SMTC), the L1-RSRP overlaps with measurement gap (MG).

11. A user equipment (UE), comprising:
a transceiver that transmits and receives radio frequency (RF) signal with a base station in a new radio (NR) network;
a configuration receiver that receives configuration information for measurement report from the NR network;
a measurement factor circuit that determines a first measurement factor N and a second measurement factor P based on the configuration information, wherein the first measurement factor N indicates whether to perform a scheduling restriction, and wherein a measurement period for a layer-1 reference signal received power (L1-RSRP) is extended by P to compensate the L1-RSRP measurement for one or more reference signal (RS) overlapping;
a measurement period circuit that determines the L1-RSRP measurement period based on the first measurement factor N and the second measurement factor P; and
a L1-RSRP circuit that performs a L1-RSRP measurement during the measurement period, wherein the L1-RSRP is performed on at least one=configured L1-RSRP resources comprising channel state information reference signal (CSI-RS) resources and synchronization signal block (SSB) resources.

12. The UE of claim 11, wherein the first measurement factor N is determined based on configuration information of the configured L1-RSRP resources, a transmission configuration indication (TCI) state, and quasi-co-location (QCL) of L1-RSRP resources.

13. The UE of claim 12, wherein the first measurement factor N indicates to perform a scheduling restriction when the configured L1-RSRP resource is SSB resource.

14. The UE of claim 12, wherein the configured L1-RSRP resource is CSI-RS resource, and wherein the first measurement factor N indicates not to perform a scheduling restriction when the CSI-RS resource is configured with repetition-OFF and the TCI is given and QCL-D to SSB or CSI-RS with repetition-ON.

15. The UE of claim 11, wherein the UE performs a scheduling restriction by suspending a predefined set of uplink transmission and downlink reception except for remaining system information (RMSI) during a scheduling restriction period.

16. The UE of claim 15, wherein the predefined set of uplink transmission include a physical uplink control channel (PUCCH), a physical uplink shared channel (PUSCH), and a sound reference signal (SRS), the predefined set of downlink reception includes a physical down control channel (PDCCH), a physical downlink shared channel (PDSCH), and a CSI-RS for tracking, a CSI-RS for channel quality indicator (CQI).

17. The UE of claim 11, wherein the measurement period is extended by N to compensate the L1-RSRP measurement for receiving beam training.

18. The UE of claim 11, wherein the RS overlapping occurs for at least one overlapping occasion comprising the L1-RSRP overlaps with SSB measurement timing configuration (SMTC), the L1-RSRP overlaps with measurement gap (MG).

19. The UE of claim 11, wherein the L1-RSRP measurement is a L1-RSRP procedure for a candidate beam detection.

20. The UE of claim 11, wherein the L1-RSRP measurement is a L1-RSRP computation for beam reporting.
